(19) United States
(12) Patent Application Publication
(10) Pub. No.: US 2010/0000980 A1
(43) Pub. Date: Jan. 7, 2010

(54) Induction Heating System with Versatile Inductive Cartridge

(76) Inventor: Bogdan Popescu, Redmond, WA (US)

Correspondence Address: Bodgan Popescu, 6228 159th Place NE, Redmond, WA, 98052, US

(21) Appl. No.: 12/493,077

(22) Filed: Jun. 26, 2009

Related U.S. Application Data
(60) Provisional application No. 61/133,809, filed on Jul. 2, 2008.

(51) Int. Cl. H05B 6/02; H05B 6/12

(52) U.S. Cl. 219/201; 219/438

(57) ABSTRACT

Disclosed are devices and systems for inductive heating of a liquid or food, which comprise versatile inductive heating cartridges. To be able to use a normally inductively non-heatable cup or vessel made of a generally dielectric material with an induction heating unit, a removable cartridge made of an inductively heatable material is inserted into the vessel. In one embodiment, the cartridge is retained in the vessel by an attachment functionality which prevents the cartridge from sliding or flipping when the cup or vessel is tipped to serve or pour. The attachment functionality is disengageable, and the cartridge may be transferred from cup to cup or vessel to vessel by the user. In another embodiment, the cartridges are configured to more efficiently work with the “pot detection” circuits of modern inductive hot plates or ranges. In another embodiment, the cartridge includes an RFID tag, antenna, and sensor package.

### CROSS-REFERENCE TO RELATED APPLICATIONS

This application claims priority to U.S. Provisional Patent Application Ser. No. 61/133,809, filed 2008 Jul. 2, from which priority is claimed, and which is herein incorporated in full by reference.

### TECHNICAL FIELD

This invention is related to devices for inductive heating of foods or liquids and vessels and appliances for use therewith.

### BACKGROUND

A long tradition of electrical heating of a food or liquid in a cup or vessel relies on the use of resistive electrical heating elements directly or indirectly contacted with the vessel. As representative of the art, heat is either transferred through the base or walls of the vessel or generated in the vessel's baseplate. Basal heating can be seen for example, in U.S. Pat. Nos. 3,778,594 to Wightman, 4,523,083 to Hamilton, and 4,980,539 to Walton. Modifications of the base of the vessel to improve heat transfer are disclosed in U.S. Pat. Nos. 6,192,787 to Montalto and 7,022,946 to Sanoner. Lateral wall heating is seen in U.S. Pat. Nos. 6,082,114 to Leonoff and 6,870,135 to Hamm, for example. Thus the familiar elements of the art involve conventional heat transfer by heating the base or side wall of the vessel. Similar devices have been provided for other vessels, for example baby bottles, as described in U.S. Pat. No. 2,640,907 and US Pat. Appl No. 2008/0087659, and references cited therein.

Magnetic induction heating is both faster and more energy-efficient than traditional resistive or gas stove units, and is a “green” technology. According to industry figures, induction heating efficiency is about 90%, as compared to 40% for gas burners and 47% for electric ranges. Advantageously, the stovetop or “hob” is not heated, reducing the risk of burn injury and fire. Unwanted radiative and convective heating of the surrounding workspace is also reduced. However, the range of vessels that can be used with these systems is somewhat limited. Electrically conductive materials like ferromagnetic metals and aluminum or copper can all be used, but their requirements are quite different and usually induction heating units are designed to work with either one or the other or the prices are driven significantly up. It has been largely accepted that ceramic, glass, or plastic vessels cannot be used with induction heating systems.

Specially fabricated vessels are also used for this technology, the base of the vessels may comprise several metal layers, at least one of which evolves heat when exposed to an oscillating magnetic field.

Ferromagnetic materials, for example, respond to oscillating magnetic fields by heating. The magnetic field generated by a coil generates eddy currents and magnetic hysteresis in the ferromagnetic material, leading to heating in direct relation to the electrical power expended. This well known phenomenon has been used for inductive ovens, hotplates, and the like.

The new inductive heating technologies have been applied in a manner analogous to the older art of resistive heating. The wall of the vessel is somehow heated and the heat finds its way to the food or beverage inside the vessel. This can be seen for example in U.S. Pat. No. 4,110,588 to Holz, where inductive energy is used to heat a metal base of a cup. As recognized by Kim, in U.S. Pat. No. 6,936,799, the question as to what material the base of the cooking container is made of must be first answered in order to determine the nature and power of the inductive pulses applied thereto. Kim devises a circuit for differentiating ferromagnetic and dielectric vessels, but offers no solution as to how to apply inductive heating to dielectric and non-ferromagnetic vessels.

Other pot detection circuitry is described by Moreland (U.S. Pat. No. 3,796,850). Moreland observes that the hob may be provided with a permanent magnet positioned under a dielectric ceramic glass surface in order to detect the presence of a suitable vessel for inductive cooking before applying power as a matter of safety.

Descriptions of inductive appliances for cooking include, while not cumulatively, Ogino (U.S. Pat. No. 4,595,814), Aoki (U.S. Pat. No. 4,638,135), Panecki (U.S. Pat. No. 4,908,489, Boys (U.S. Pat. No. 5,450,305); and Clothier (U.S. Pat. No. 6,953,919), the latter including an extensive review of the literature surrounding inductive cooking and making provision for control via an RFID “class of object” tag in the handle of a specially formed vessel. Again, no provision is made for heating the contents of vessels made without an inductively heatable baseplate.

Modification of the base of the vessel has been considered. As described for example in U.S. Pat. No. 6,635,855 to Scaburri, in order to more intimately associate a ferromagnetic material with the baseplate of a non-ferrous vessel, the vessel is diecast with embedded wire gauze in the base. This is an improvement over the prior art, where the ferromagnetic gauze was simply applied underneath the non-ferrous baseplate so that the base of the vessel is heated from outside. Although this method ensures that the wire gauze does not dissociate from the vessel, perhaps not surprisingly, both such methods were reported to result in warping or breakage of the base.

Harnden, in U.S. Pat. No. 3,745,290, addresses the use of metal sheeting applied within an outer shell that is not inductively heatable. The outer shell, with baseplate, is modified with an inner lining by application of a vapor deposited metallic coating, foil or sheet composite, embedded powdered metal or embedded wires. In expired U.S. Pat. No. 3,786,222, disposable aluminum foil is wrapped directly around the food or inserted in a container, however, inductive heating with aluminum is not generally accepted in the market because of the need for specialized resonant circuitry, again defeating the object of a inductive heating element for exchangeable use with containers that are not inductively heatable.

### SUMMARY

In extending the breadth of applications for inductive heating to new consumer markets, no prior consideration has been given to the advantages of reversibly inserting a ferromagnetic material inside a non-inductively responsive vessel, where the ferromagnetic material is packaged as a reusable, immersible member that can be transferred from cup to cup or vessel to vessel as desired by the user. Such a cartridge may be used with any vessel that does not shield the cartridge from the magnetic field of an external inductive heating unit. Food or liquid in vessels made of ceramic, glass or plastic, which are not inductively heatable, may be heated with the insertable cartridge of the invention.

In the devices and applications disclosed herein, an induction “cartridge” or “puck” made of an inductively heatable member, for example a sheet or layer of a ferromagnetic material configured as a disk or plate, is inserted into and rests in proximity to the bottom or a lower aspect of the inside cavity of a vessel, where it can be heated by the primary coil of an inductive heating unit on which the vessel is placed. Different coil geometries can be chosen to best work with a specific induction cartridge configuration by following the contour and the likely paths of the induced eddy currents. The cartridge layer is also selected with dimensions, volume distributions, thicknesses, and magnetic permittivity suitable for optimal dissipation of power as heat.

Applicable vessels include cups, bowls, coffee mugs, mugs for a car, crock pots, kettles, baby bottles, and the like, of off-the-shelf designs and sizes, or more generally, any portable vessels made of dielectric materials like ceramic, glass, or plastics suitable for use with food or drink. The vessel has at least a base composed substantially of or composed essentially of a dielectric material, which will not shield the inside cavity of the vessel from the penetration of the external oscillating magnetic field of the primary coil.

In order to allow for drinking or sipping the liquid from the vessel without removing the induction cartridge, which otherwise could slide or flip when the vessel is tilted for gravitational drinking, retaining means are provided. The induction cartridge is reusable and is easily removable for cleaning. For an induction cartridge design to be used with baby bottles, a buoyant float in the cartridge will cause the cartridge to float in the bottle when inverted so that it does not obstruct the flow of the liquid to the nipple.

In another aspect, the cartridge includes an RFID (Radio Frequency Identification) tag that can be detected and recognized by an induction heating unit. The coil used for induction heating can be used for generating and receiving the RFID signals or a secondary coil and antenna at generally a higher frequency can be used. A suitable frequency and separation distance, typically a few centimeters, for reliable transmission of data is chosen. Induction heating units may be designed to power down unless a compatible cartridge with RFID tag is detected, a feature that serves to enhance safety if desired. Advantageously, the transmission from the RFID tag can also selectively activate and deactivate the induction coil to maintain a prescribed temperature when used with an embedded temperature sensor in the cartridge. By potting the tag and associated circuitry in a moisture resistant matrix, moisture sensitivity is overcome. Unlike the prior art, the RFID chip on the inventive cartridge may be moved from cup to cup or pot to pot. In prior art pots for induction cooking, the RFID chip is placed in the handle of the pot because the antenna would be RF shielded and ineffective if placed inside the cooking cavity of a conductive pot.

In one embodiment of the invention, the induction cartridge assembly with RFID chip may have a “latching functionality” for securing the cartridge in the vessel; in another embodiment, the cartridge with RFID chip is not provided with any latching functionality, depending on the specific application and the needs of the user. When present, the latching function may be reversibly disengaged, so that for either embodiment the cartridge may be transferred from cup to cup or vessel to vessel by the user without loss of utility.

Thus in a first embodiment, the invention is a reusably insertable heating cartridge for inductively heating a food or a liquid in an inside cavity of a cup or vessel, the cup or vessel having a base and walls, where the base is composed substantially of a dielectric material, which comprises: a) a cartridge body for insertion into the inside cavity of the cup or vessel, the cartridge body having upper face, peripheral edge and undersurface, and further comprising a layer, sheet or plate of an inductively heatable material, the sheet or layer having dimensions, volume distribution, and material properties configured to dissipate power as heat when operatively coupled to an external oscillating magnetic field penetrating the base or walls and contacting the cartridge body; and b) further comprising a latching functionality for securing the cartridge body within the cavity of the cup or vessel, wherein the latching functionality is disengageable by the user for transferring the cartridge from cup to cup or vessel to vessel. The sheet, plate or layer of inductively heatable material optionally may also comprise an array of perforations or dimples.

In a second embodiment, the invention is a reusably insertable heating cartridge for inductively heating a food or a liquid in an inside cavity of a cup or vessel, the cup or vessel having a base and walls, where the base is composed substantially of a dielectric material, which comprises: a) a cartridge body for insertion into the inside cavity of the cup or vessel, the cartridge body having upper face, peripheral edge and undersurface, and further comprising a layer, sheet or plate of an inductively heatable material, the sheet or layer having dimensions, volume distribution, and material properties configured to dissipate power as heat when operatively coupled to an external oscillating magnetic field penetrating the base or walls and contacting the cartridge body; and b) encapsulated in the cartridge body, i) an RFID tag and antenna; and ii) optionally a temperature sensor in electronic communication with the RFID tag and antenna. The sheet, plate or layer of inductively heatable material optionally may also comprise an array of perforations or dimples.

In a third embodiment, the invention is a reusably insertable heating cartridge for inductively heating a food or a liquid in an inside cavity of a cup or vessel, the cup or vessel having a base and walls, the base composed substantially of a dielectric material, which comprises: a) a cartridge body for insertion into the inside cavity of the cup or vessel, the cartridge body having upper face, peripheral edge and undersurface, b) wherein the cartridge body comprises a sheet or plate of an inductively heatable material; and wherein the sheet or plate is further characterized as having an array of perforations or dimples configured to increase apparent inductive load resistance of the heating cartridge due to eddy current losses when operatively coupled to an external oscillating magnetic field penetrating the base or walls and contacting the cartridge body. Optionally, the cartridge body may also comprise an RFID tag with antenna and sensor package. Optionally, the cartridge body also comprises a mechanical or magnetic latching functionality for detachably securing the cartridge in the cup or vessel.

Combinations of the above with vessels or with induction heating or cooking units are also conceived. These combinations include combinations of a cartridge and a vessel or a cartridge configured to operate with an induction heating unit. Such systems include induction hot plates or other appliances supplied with compatible electronics and provision for sensor-mediated power control and safety features.

In this way, new applications for inductive heating are found. Vessels lacking an inductively heatable base or baseplate material may be made responsive for induction heating by inserting an induction heating cartridge formed as a reusable, immersible member that can be transferred from cup to cup or vessel to vessel as desired by the user.

### BRIEF DESCRIPTION OF THE DRAWINGS

The teachings of the present invention can be more readily understood by considering the following detailed description in conjunction with the accompanying drawings and claims, in which:

FIG. 1 is a cross-sectional view through an immersible cartridge with body, coating and internal layer of an inductively heatable material.

FIG. 2 illustrates use of an immersible cartridge with ferromagnetic layer to heat a liquid in a mug on an inductive heating unit. Also shown is a retaining magnet for securing the cartridge in the mug.

FIG. 3 illustrates use of the magnet to retain a cartridge with ferromagnetic layer in a mug when tipped so that any fluid drains out.

FIG. 4 shows a perspective view of an immersible cartridge with elastic retaining prongs for insertion into a cup or mug.

FIG. 5 shows a perspective view of an immersible cartridge with perforations to increase eddy current density and reduce weight.

FIG. 6 is a schematic view of a cup with inserted cartridge having a inductively heatable layer formed as a perforated collar and a hob adapted with vertical coils for coupling to the cartridge. The perforated collar serves mechanically to retain the cartridge in the cup.

FIG. 7 is a cross-section of an elastic collar for reversibly retaining an immersible cartridge in a cup adapted with center post for receiving the cartridge.

FIG. 8 is a cross section of a mechanical latch for reversibly retaining an immersible cartridge in a cup adapted with center post for receiving the cartridge.

FIGS. 9A and 9B show an immersible cartridge with extensible clip for attachment to the wall of a mug or other vessel.

FIG. 10 is a schematic in cross-section of an immersible cartridge in a cup. The device is provided with a detachable magnet placed in an adaptor that is fitted on the outside base of the cup.

FIG. 11 is a schematic in cross-section of an immersible cartridge and cup combination, where the cup is provided with an embedded magnet for affixing the cartridge.

FIG. 12 is a schematic showing an immersible cartridge with external retaining disk, each with a mating magnet.

FIG. 13 is a schematic of an immersible cartridge with buoyant floats disposed laterally. The floats compressively affix the cartridge within the cup, and when not properly seated, the cartridge floats to the surface of the liquid.

FIGS. 14A and 14B depict a buoyant cartridge for use in specialized vessels.

FIGS. 15A and 15B depict use of the cartridge of FIGS. 14A-B a baby bottle fitted with a magnetic adaptor for the base of the bottle.

FIGS. 16A, 16B and 16C illustrate alternative material cross-sections.

FIG. 17 shows a cutaway view of a combination of a cup, internal cartridge with RFID tag with temperature sensor, and an inductive heating unit.

FIG. 18 is a cross-sectional view of an inductive heating cartridge with RFID tag and temperature sensor. In this embodiment, no retaining functionality is required.

FIG. 19 is a view of a combination of a cup, internal cartridge with RFID tag, and inductive heating unit.

FIG. 20 is a view of an inductive heating cartridge with RFID and temperature sensor adapted for use in a bowl or pan where no retaining functionality is required.

FIG. 21 is a block circuit diagram of an RFID chip with antenna assembled in a cartridge for induction heating unit communication and control.

FIG. 22 is a plot of temperature versus time for the heating of 0.75 L of water with an inductive immersible cartridge of the invention.

### DETAILED DESCRIPTION

Although the following detailed description contains many specific details for the purposes of illustration, one of skill in the art will appreciate that many variations, combinations, substitutions and modifications of the following details are within the scope of the invention. Accordingly, the exemplary embodiments of the invention described below are set forth without any loss of generality to, and without imposing limitations upon, the claimed invention.

### DEFINITIONS

Certain meanings are defined here as intended by the inventor, ie. they are intrinsic meanings. Other words and phrases used here take their meaning as consistent with usage as would be apparent to one skilled in the relevant arts. When cited works are incorporated by reference, any meaning or definition of a word in the reference that conflicts with or narrows the meaning as used here shall be considered idiosyncratic to said reference and shall not supersede the meaning of the word as used in the disclosure herein.

“Cartridge” or “puck”: an insertable layer of an inductively responsive material formed as a body or member having a shape and stiffness adapted for handling and for insertion into the inside cavity of a cup or vessel. The cartridge body is generally a thin, stiff disk or puck-like form adapted and contoured for close apposition to the base of a vessel or cup when inserted therein. When the base of the vessel or cup is placed on the hob of an induction heating system, the inductively responsive layer of the cartridge is in proximity to and becomes coupled to the oscillating external magnetic field generated by the induction heating system. The cartridge body is optionally provided with a food-safe exterior coating, and is optionally configured with mechanical or magnetic functionality for attaching and securing the cartridge inside the vessel.

Inductive heating: relates to heating by electrical induction, where an oscillating magnetic field heats an inductively responsive material by induction of eddy currents and, in case of ferromagnetic materials, by magnetic hysteresis.

Inductively heatable materials: materials in which significant electrical current is induced when said material is subjected to a changing magnetic field, currents which, by the Joule effect, produce heat; ie. materials that are responsive to an oscillating magnetic field and dissipate the power of the field by generating caloric heat. These materials include without limitation iron, cast iron, steel, carbon steel, stainless steel, martensitic stainless steel, cobalt steel, chrome steel, nickel steel, silicon steel, magnetic stainless steel, spring steel, mu-metal, their alloys and their combinations. Aluminum and copper and their alloys are responsive to magnetic fields but their use is not practicable with the majority of currently available inductive heating appliances. In one embodiment, the inductively heatable material has a Curie temperature selected as a safety feature for the application.

Insertable: something inserted or to be inserted, able to be inserted; able to be put into something else, as in an “insertable cartridge”, where the cartridge is inserted into the interior cavity of a vessel.

RFID: (“radio frequency identification”) refers to a data collection technology that uses electronic tags for transmitting data. The tag, also known as an “electronic label,” “transponder” or “code plate,” is made up of an RFID chip attached to an antenna. Transmitting in the kilohertz, megahertz or gigahertz ranges, RFID tags may be battery-powered or derive their power from the RF waves coming from the reader. Like barcodes, RFID tags identify items. However, RFID tags hold more data than barcodes and unlike barcodes, which must be in line of sight to the scanner for reading, RFID tags do not require line of sight and can be embedded within a body and immersed in a liquid while still functioning. “Passive” tags have no power source but use the electromagnetic waves from the “reader” or primary coil to energize the chip and transmit back (backscatter) their data. Some tags can include a sensor and A/D converter that, when interrogated, reports the temperature of a thermal mass in which the tag is embedded, or other sensory information.

Hob: as used here, is the flat top part of a cooker, or “cook-top”, containing thereinunder an inductive heating coil or coils. The induction transfer coil is typically a planar spiral located immediately underneath and coplanar with the hob but may also include more complex structures with coils extending out of plane to more efficiently couple the driving magnetic field with the load device. Hobs may include portable desktop appliances such as coffee warmers.

Induction Heating System, appliance or “unit”: includes a power supply, typically with provisions for rectifying and filtering an AC voltage, and an inverter for supplying a variable current to an inductive coil. Generally, the coil is part of a parallel or series LC tank circuit and is operated at or in the vicinity of the resonant frequency. Typically, the tank circuit has little resistive loss except due to heating as a result of magnetic field coupling with the cartridge body layer, which functions as a resistive load in parallel with the LC tank. To drive the circuit, resonant switching is generally achieved either by half-bridge series resonant converters or by the less expensive quasi-resonant converters, and is generally zero voltage switching (ZVS) or zero current switching (ZCS). For example, insulated gate bipolar transistors (IGBT, U.S. Pat. No. 4,364,073) have made driving these resonator circuits much more efficient. Inductive systems may include subsystems for power control and safety features such as “pot detection”. Operation and design of inductive heating systems are generally known in the art.

A “vessel” is an article generally for preparation of or for containing a food or beverage, having a peripheral wall, a lip, a generally flat bottom with external base, and an internal or inside cavity, where the inside cavity is generally accessible through an opening at the top of the vessel. As suitable for use with the cartridges of the invention, the baseplate, including base and lowermost aspect of the vessel, is ‘substantially composed of’ or ‘essentially composed of’ a dielectric material. For example, the vessel may be made of ceramic, earthenware, stoneware, porcelain, glass, plastics in general, treated paper, and so forth. As used here, the inside wall is generally intended to withstand temperatures up to 290° C. (˜550° F.), although not limited thereto.

### DESCRIPTION OF THE FIGURES

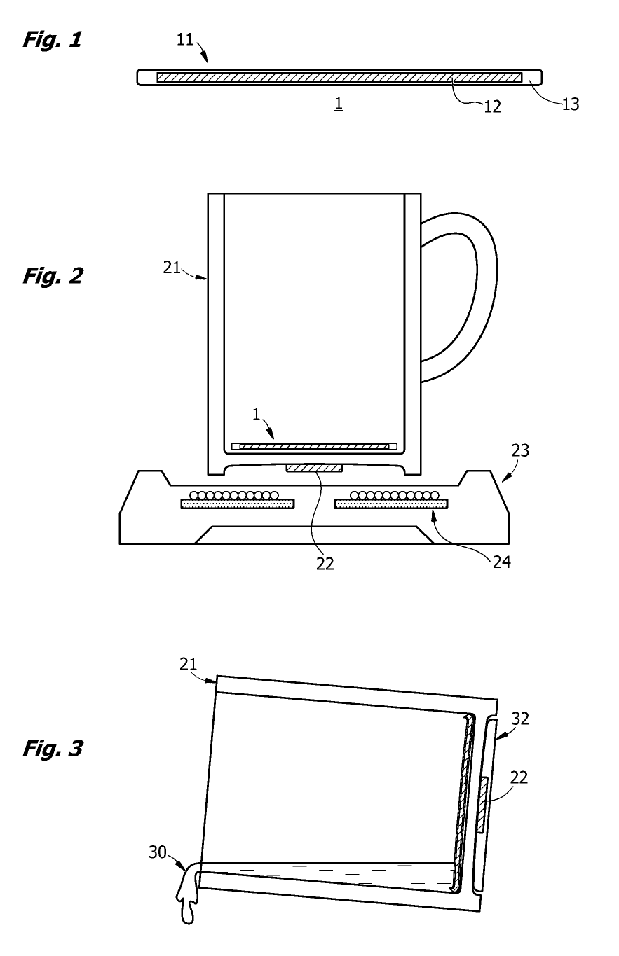

Turning now to FIG. 1, illustrated is a cross-sectional view through an immersible cartridge (1) of the invention with body (11) formed of a layer, sheet or plate (12) of an inductively heatable material and optional sanitary coating (13). The inductively responsive material is chosen so that sufficient electrical current, known as eddy currents, will flow in closed paths in the material to produce I²R dissipation; where the eddy currents are associated with induced voltages developed in the material by the application of a changing magnetic field. Unlike an ordinary vessel, the inductive cartridge can be more specifically tailored to be inductive heating. The relative thickness, dimensions, magnetic permittivity, and volume distribution of the material may generally be chosen to meet certain requirements for eddy current losses and heat distribution over the body of the cartridge.

Ferromagnetic materials are preferred due to their magnetic permeability and relative higher electrical resistance. Suitable materials include iron, cast iron, steel, carbon steel, stainless steel, martensitic stainless steel, cobalt steel, chrome steel, nickel steel, silicon steel, magnetic stainless steel, spring steel, mu-metal or composites thereof. Aluminum and copper may be used for induction heating but their requirements are more demanding than ferromagnetics. They are in general not usable with current on-the-market induction cooking appliances.

Useful thicknesses for the present cartridges are generally in the range of 0.3 mm to about 1.3 mm. Disposable aluminum foils of 0.003 to 0.05 millimeters (about 0.1 to 2 mils) proposed by Harnden (see FIG. 6 of U.S. Pat. No. 3,786,222, where results are shown for a range of 0.1 to 2 mils) do not, by themselves, provide the stiffness that would be required for reusability and have low thermal mass and low lateral heat transfer capabilities.

The performance of a sheet material can be modified by selective perforation to modify the volume distribution, which changes the density of the eddy currents according to the volume distribution per unit surface area. Perforations may be densely spaced as arrays and hole diameters can be small as required to achieve coupling. There may also be dimples rather than full-thickness holes.

A set of cartridges may be provided in various nested dimensions so that a cartridge most well fitted to a particular vessel may be selected. The cartridge does not inelastically impinge on the walls of the vessel. This approach eliminates the problem of thermal expansion mismatch between the baseplate of the vessel and an embedded metallic insert.

A coating is required if the inductively heatable layer is not compatible with comestibles. Such coatings as are suitable include enamel, glazes, such as ceramics, and a dip or encapsulation in a plastic such as polyimide, silicon, or a fluoropolymer.

In operation, the heated induction cartridge (1) lying at the bottom of a vessel such as a coffee cup (21) will be heated by an oscillating external magnetic field, and in turn will use thermal convection to efficiently heat the liquid inside, as shown in FIG. 2. Cup (21) is shown seated on an inductive heating unit (23). The induction cartridge in this embodiment is composed of a ferromagnetic layer and is attached or retained in its place near the bottom of the cup in close proximity to the primary coils (24) of the heating unit by use of a retaining magnet (22) installed under the base of the cup. The inductive cartridge may be removed from the cup at will and may be inserted in a second cup or alternate vessel as desired by the user. A grip or handle useful for this purpose may be added to the cartridge body if desired.

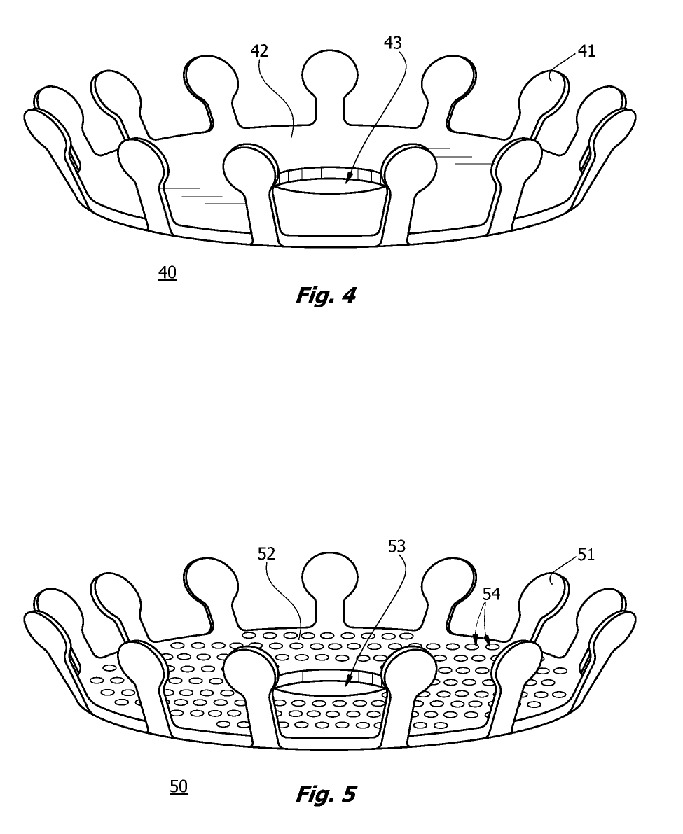

The advantage of the retaining functionality is demonstrated in FIG. 3, where the cup (21) containing a liquid (30) is tilted to pour out or drink the liquid while retaining the cartridge in place, which happily remains magnetically attached to the inside bottom of the vessel. The magnet (22) acting as a magnetic “latch” is affixed under the base of the cup in an adaptor (32) shown here. If not so restrained, the hot cartridge could tumble out of the cup while the user is drinking from the cup for example, a circumstance to be avoided because it might result in burns, spills, and water damage. In some embodiments, as will be described below, a “latching functionality” or “attaching device” is not required.

As an overview, the latching functionality or “retaining means” for attaching and securing the cartridge in the cup or vessel may be selected from mechanical “latches” or magnetic “latches”. Embodiments of the mechanical latch functionality include, without limitation, “spring” or “impingement” latches, “friction” latches, “clip” latches, barbed latches, threadable latches, and “pinch” latches, for example. Magnetic latches rely on magnetic attraction to secure the cartridge in the vessel. Generally a magnet and a magnetically responsive material are positioned on opposite sides of the base of the vessel to form the magnetic latch, but optionally the magnet may be embedded in the base of the cup.

The latching functionality is disengageable by the user. The user, by disengaging the mechanical or magnetic latch, may remove the cartridge from one cup or vessel and transfer it to another. In this way each cartridge is versatile in uses, permitting heating and cooking in any of multiple vessels as desired by the user.

FIG. 4 shows a perspective view of an immersible cartridge (40) having elastic retaining prongs (41) or projections (for insertion into a cup or mug). This illustrates a mechanical latching functionality. The spring-like prongs (41) arrayed around the peripheral edge of the central disk (42) of the cartridge are deformed by insertion in the cup and wedge the cartridge against the bottom inside surface, ensuring optimal coupling with the power of the external coil of the heating unit. The cartridge is punched out at the center (43) to better match the active surface of a conventional coil. It has been found that such plates are not heated uniformly, but the heating patterns are more intense along the eddy current paths which most closely follow the geometry of the coil. The cartridge may also be contoured across the disk (42) so as to more closely appose the bottom contour of a conventional coffee mug. While this feature contributes to a modest improvement in efficiency, it also increases the stiffness of the center disk so as to resist bending during frequent handling. It also reduces weight. Inductive cartridges of this type may be coated with a sanitary finish or may be used without coating if formed of a suitable food-safe material. If needed, a coat of fluoropolymer such as Teflon*), or a ceramic overcoat may also be used.

FIG. 5 is a perspective view of an immersible cartridge (50) with perforations to increase eddy current density. Peripherally disposed prongs (51) are spring-like and are used to secure the cartridge in a coffee cup or mug, for example. The perforations (54) in the center disk (52), counterintuitively, have the effect of improving the induction process and are effective for example in stainless steel plates having a thickness of about 0.03 inches with a hole size of about 0.1 inches and an average hole separation of about 0.15 inches, while not limited thereto. Body disk (52) and center hole (53) correspond to the shape of a conventional inductive heating coil.

FIG. 6 is a schematic view of a cup (61) with an inserted cartridge (60) having a inductively heatable layer (62) formed with a perforated collar (63) and a heating unit (65) adapted with vertically wrapped coils (66) for coupling to the collar (63) of the cartridge and supplementing the conventional planar spiral coils of the hob (67) in this embodiment. The spokes (64) of the perforated collar are diametrically compressible to mechanically retain the cartridge in the cup. Other vessels may be similarly adapted.

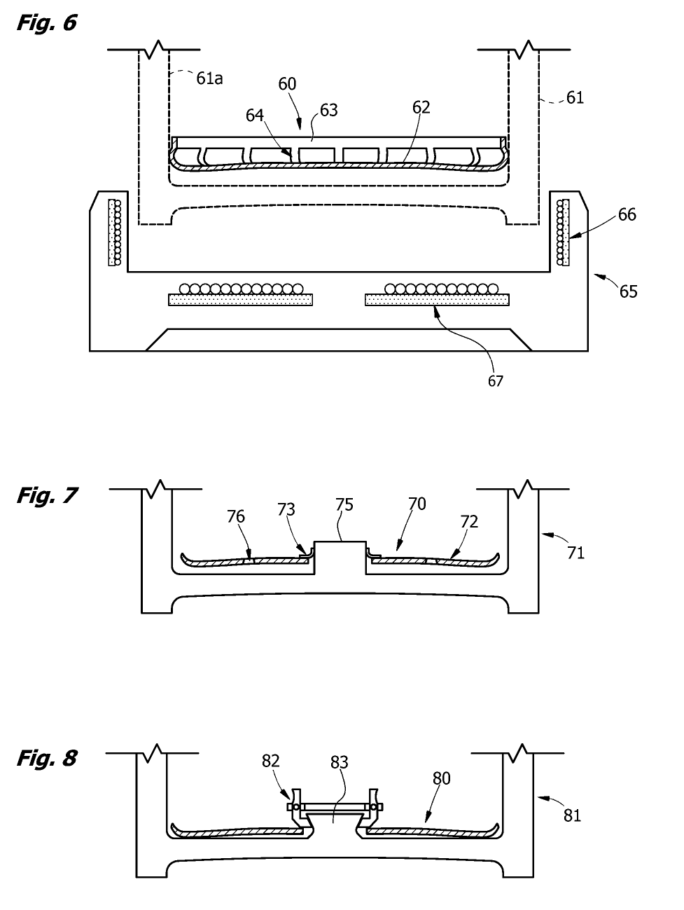

FIG. 7 shows a cup (71) containing a cartridge (70) with central open core fitted with an elastic friction collar (73) for reversibly retaining the cartridge on a center post (75) adapted for receiving the collar. The center post is formed as a projection of the base of the cup. Also shown are perforations (76) in the disk body (72) for extraction of the disk. A pair of tongs or other extraction device is used to grip the disk at perforations (76) and pull it from the cup.

FIG. 8 shows a cup (81) fitted with an inductive cartridge (80) having a mechanical latch (82). The cup is adapted with a center post (83) for receiving the cartridge. The mechanical latch is mounted on a bezel and is barbed to affix itself to the centerpost of the cup and can be removed by disengaging the barbs.

In related configurations (not shown) the cartridge can be provided with peripheral externally projecting barbs for fitting into barb-receiving receptacles, or may be threaded into receiving channels or mounting pegs on the inside walls of the vessel. Similarly, a pair of slots extending from top to bottom on the inside walls of a mug or other straight walled vessel may be configured to receive a cartridge having mating male pins; the slots terminate in an “ell” so that a small twist of the cartridge secures it at the required depth in the mug by the pins. More generally, a threadable latching feature includes at least two contralaterally placed pins or slots on the peripheral edge of the cartridge body, where the pins or slots are configured for engaging mating threadable channels or bosses in the body of the vessel.

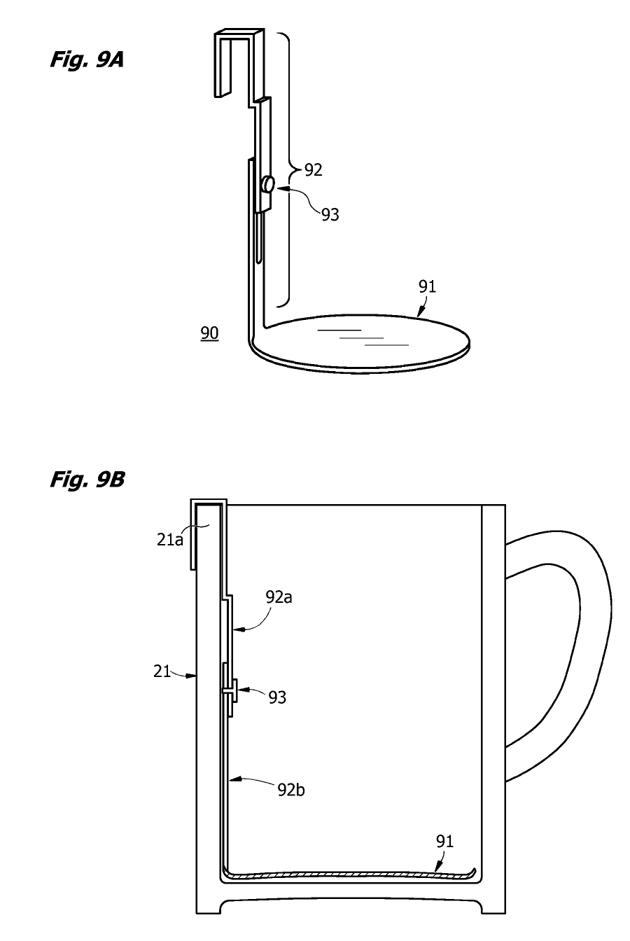

FIGS. 9A and 9B show a cup (21) fitted with an immersible cartridge (90) with clip (92) for attachment to the lip (21a) of the wall of the cup or other vessel. The clip (92) is optionally extensible to better fit the vessel and ensure that the disk (91) of the cartridge body is in close apposition to the inside bottom of the vessel cavity. The clip arm may be formed with a slotted mounting arm (92b) and extensible arm (92a) with tensioning pin (93) for adjusting the fit. Alternatively, the clip arm may be a single piece plastic molded part that is proportioned to generally fit a standard coffee mug.

We turn now to magnetic latches for affixing the cartridge in a vessel. For convenience of illustration, a coffee cup (21) is used to illustrate various combinations, but the magnetic latches may be adapted to other dielectric vessels as required. The magnetic latch is a latching or attachment functionality and is not used as an inductive heating element. Ceramic magnets deficient in inductive coupling strength may be used in place of ferromagnets in the construction of magnetic latches. As before, the attachment of the cartridge in the vessel is reversible so that the cartridge can be exchanged between various vessels at the will of the consumer. The magnetic latch is a combination of a magnetically responsive element in the body of the cartridge and a magnet applied externally to the base of the vessel or embedded within the base. The magnet and magnetically responsive elements are magnetically attracted, thereby magnetically securing the cartridge within the vessel.

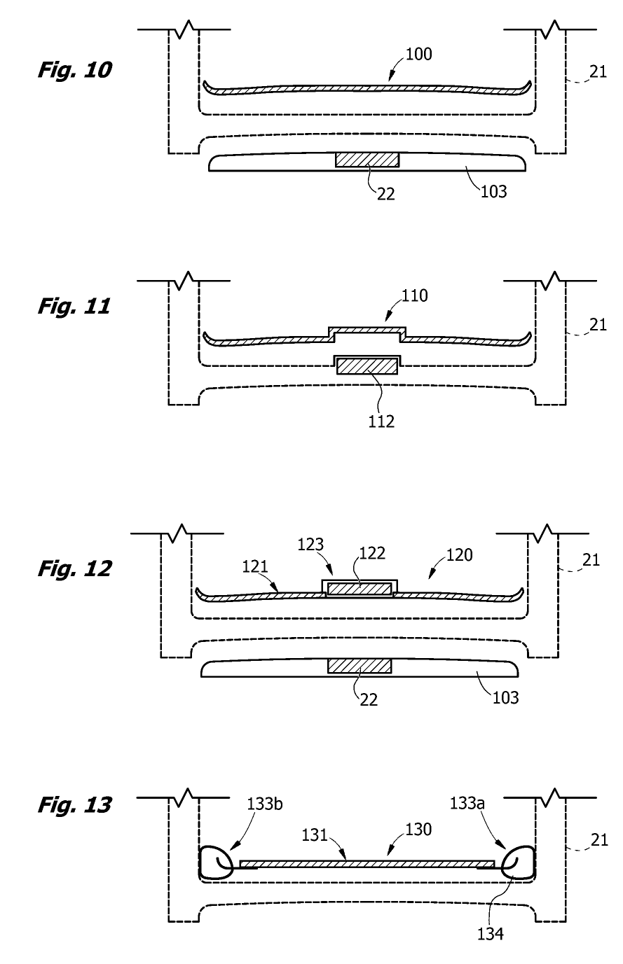

FIG. 10 is a schematic of a cup (21) with internal reusable attachable cartridge (100) shown in cross-section. The device is provided with a detachable magnet (22) in an adaptor plate (103) that is fitted on the outside base of the cup.

FIG. 11 is a schematic of a cup or other vessel (21) and shaped cartridge (110) in cross-section showing an immersible cartridge-and-cup combination, where the cup is provided with an embedded magnet (112) for magnetically attracting and retaining the ferromagnetic plate or disk forming the body of the cartridge.

FIG. 12 is a schematic of a cup or other vessel (21) showing an immersible cartridge (120) with on-board accessory magnet (122). The on-board accessory magnet is affixed to the disk body (121) of the cartridge in a molded housing (123). A magnetic latch magnet (22) affixed to the base of the vessel in an adaptor plate (103) is used to reversibly capture the cartridge in the bottom of the cup so that the vessel may be safely inverted without dislodging the cartridge.

FIG. 13 is a schematic of a cup (21) fitted with an immersible cartridge (130) with buoyant floats (133a,133b) disposed laterally and affixed to the disk body (131) at the peripheral edges of the cartridge. The buoyant members may be made of closed-cell foam (134), for example. The buoyant members also compressively affix the cartridge within the cup (21), and when not properly seated, buoy the cartridge to the surface of any liquid in the cup. Use of buoyant cavities in the cartridge is a safety feature because it alerts the user and prevents heating of the cartridge when the cartridge is not properly secured in the bottom of the vessel. The buoyant cavities may be foam, gas bladders, rigid cavities, or other suitable buoyant members.

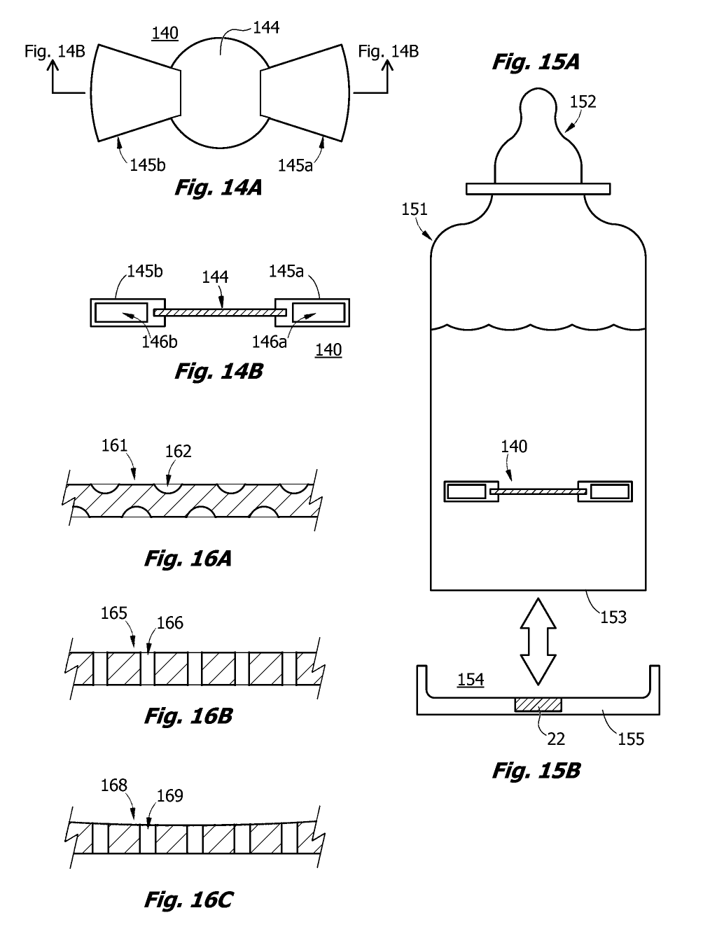

FIGS. 14A and 14B depict a buoyant cartridge (140) for use in specialized vessels. Shown first is a plan view (FIG. 14A) and a cross-sectional view (FIG. 14B). In plan view, the device consists of a central disk (144) of an inductively heatable material and two hollow wing sections (145a,145b) that serve as floats. Each float contains a gas-filled or foam-filled cavity (146a,146b). In operation, a magnetic latch is used to hold the cartridge at the bottom or lower aspect of a vessel cavity, but when the magnetic latch is released, the cartridge floats on the surface of the liquid.

FIGS. 15A and 15B depict use of the cartridge (140) of FIGS. 14A-B a baby bottle (151). The bottle is fitted with a magnetic latch assembly (154) with magnet (22) and adaptor plate (155) that is mounted on the base (153) of the bottle to secure the cartridge at the bottom of the bottle during the induction heating process. The bottle with magnetically captive cartridge is first placed on an induction heating unit for heating. When heating is completed, the magnetic latch assembly (154) is detached from the bottle (double arrow) and the cartridge floats to the surface of the warm liquid. When the baby bottle is inverted, the cartridge floats away from the nipple (152), allowing the baby to suckle. Alternatively, if the magnetic latch is not detached, the cartridge will remain magnetically latched to the base of the bottle and will not impede flow.

FIGS. 16A, B and C represent cross-sections of a thin sheet, plate or layer of an inductively heatable material. As shown, the volume distribution per unit surface area of the thin layer may be varied by design to optimize coupling and power dissipation as heat. In FIG. 16A, a solid section of a layer or plate (161) is shown, but the aspect ratio is varied by the provision of an array of dimples (162) on top and bottom. In FIG. 16B, the plate (165) is perforated (166) at periodic or irregular intervals to increase eddy current density in the remaining solid areas. In FIG. 16C, the thickness of the plate (168) is also varied across the cross-section, optional including as shown here an array of perforations (169) through the full thickness. Dimples may be substituted for the full thickness perforations. Or the solid material layer may be a fibrous or particulate material. Sandwiched layers may also be used, for example including a heat spreader in intimate contact with the inductively heatable material. Also of interest in the fabrication of the inductively heatable sheet or layer are metallurgical and materials properties such as the size and separation of microcrystalline or granular domains in the metal, and the magnetic permittivity.

While not bound by theory, the volume distribution per unit surface area is configured to increase heating efficiency and satisfy “pot detection” circuits of conventional heating units by increasing the apparent size of the inductive load resistance sensed by the primary coil. Thus in selected embodiments, the sheet, plate or layer of inductively heatable material optionally may comprise an array of perforations or dimples configured to increase apparent inductive load resistance of the heating cartridge due to eddy current losses when operatively coupled to an external oscillating magnetic field penetrating the base or walls and contacting the cartridge body.

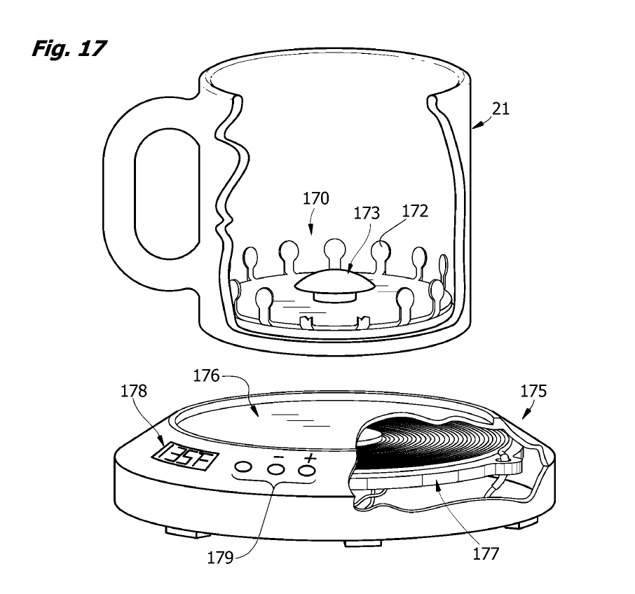

FIG. 17 shows a perspective cutaway view of a combination of a cup (21) and insertable cartridge (170) with a “capsule assembly” (173) mounted centrally on the upper face of the cartridge body. In this embodiment, the capsule assembly (173) contains an embedded RFID tag, an antenna, and a temperature sensor. The capsule may optionally also contain a handshake circuit for compatibility verification. Also shown in cutaway view is a desktop inductive heating unit (175) with hob (176), internal coil (177), and LED display functions (178). Also shown is a representation of an ON/OFF switch and temperature setpoint switches (179) that are linked to the microcontroller that controls the AC invertor powering the primary coil (177). In this embodiment, the cartridge body is provided with elastic or spring-like peripheral prongs (172) for mechanically latching the cartridge within the lower aspect of the cavity of the cup.

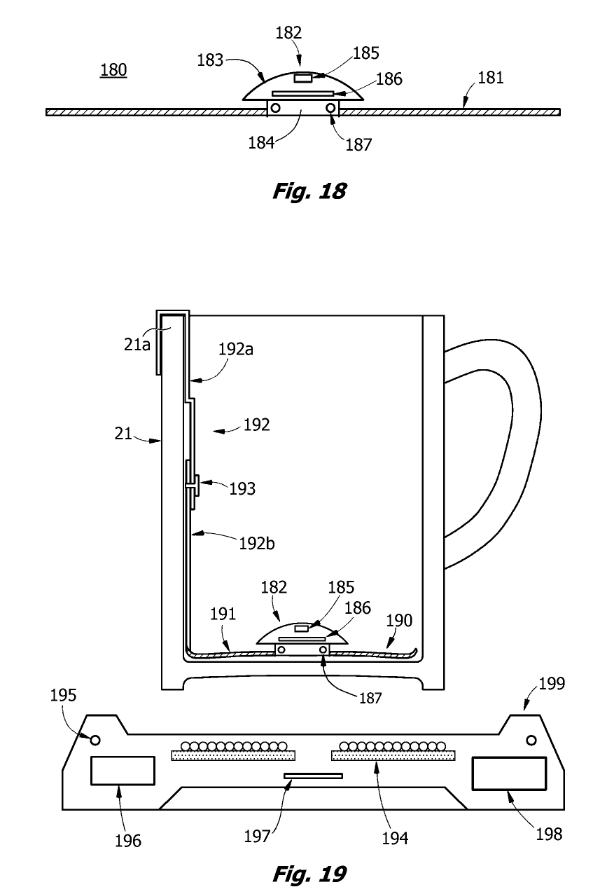

FIG. 18 is a schematic of a simplified cartridge (180) with disk body (181) and centrally mounted RFID and sensor capsule assembly (182). The capsule assembly is mounted through the disk body and an RFID antenna (187) is located within the lower stem (184) of the capsule, in this embodiment. The RFID chip (186) and a temperature sensor (182) in electronic communication with the RFID chip circuitry are embedded in the capsule housing, which also serves as a handle for inserting and removing the cartridge from a vessel. Other sensors such as a thermal overload or dry pot sensor may also be included. A latching functionality is optional. In some embodiments, the cartridge with RFID assembly is used in vessels where latching is not needed, for example in a crock pot or in a cooking bowl or pan not intended for pouring.

FIG. 19 is a cross-sectional view of a combination of a cup (21), internal cartridge (190) with capsule-mounted RFID sensor and antenna (182), and inductive heating element (199) with hob which supports the cup during heating.

The capsule assembly (182) mounted centrally in the top face of the disk body (191) contains an RFID tag or “chip” (186), linked temperature sensor (185), and antenna (187). The antenna in the capsule receives and transmits signal from a secondary coil (195) in the inductive heating unit. The RFID and sensor functions are powered passively with energy received from the unit. Contained in the inductive heating unit is an AC power supply with mains, a rectifier, an AC solid state inverter (198), the primary coil (194), a microcontroller (197) for controlling the coil, an RFID “reader” (196) linked to the secondary antenna (195), a user display and control interface, and accessory safety circuitry and wiring as are known in the art.

In addition to the RFID assembly mounted on the top face of the cartridge body, the cartridge is also modified with a handle arm (192) for inserting and removing the cartridge from the cup. The handle includes a mechanism for adjusting the length of the arm, upper extensible arm (192a), slotted mounting arm (192b), and tensioning pin (193), and may be clipped over an upper lip (21a) of the cup wall.

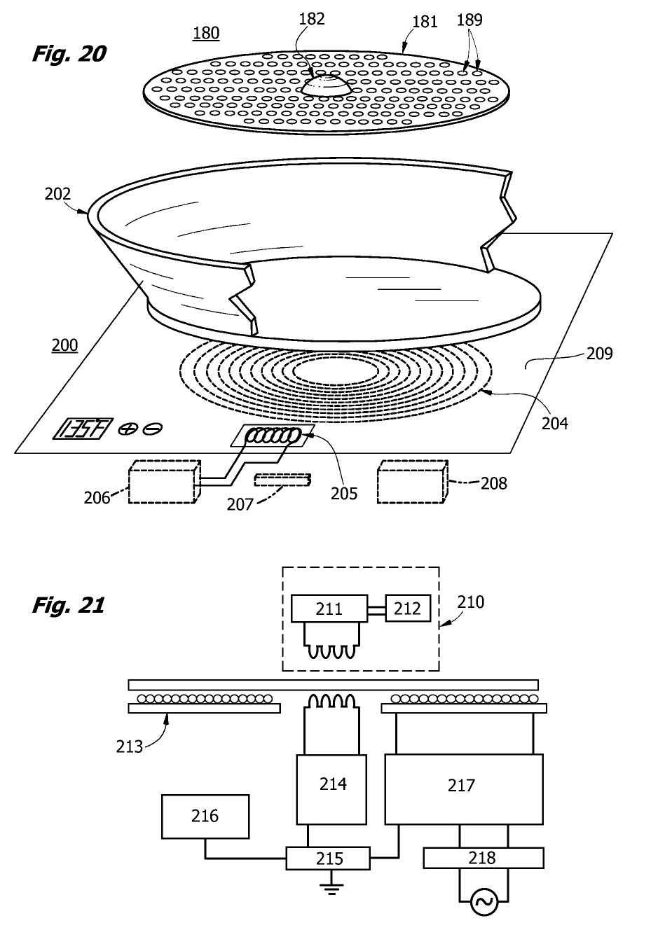

FIG. 20 is a modified perspective and schematic view of another embodiment of the inductive heating cartridge (180) of FIG. 18, with pan (202) and hob (209). The inductively heatable layer or disk (181) is fitted with a central capsule (182) containing an RFID tag and antenna. The body disk (181) contains perforations (189) to drive eddy currents at higher resistance. In this embodiment, no “latching” or “attachment functionality” is required. The body of the cartridge is depicted as a flat plate with central capsule assembly affixed to the top face. Applications in which no attachment functionality is required include general cooking in pans or bowls where the vessel is not intended to be tipped during cooking and serving. In this embodiment, the advantage of rapid transfer of the cartridge or puck from one cooking vessel to another outweighs the need or a restraining latch.

The cartridge is shown as inserting into a pan 202 and seating on a hob (209) of an inductive heating unit (200). The heating unit contains a primary coil (204) with power supply and AC invertor (208), microcontroller (207) and RFID “reader” (206). The circuit elements are interconnected, for example by mounting on a printed circuit board and wired as described below. The RFID reader includes a pick-up antenna (205) mounted under the hob, and may be used with any pan that does not shield the coupling of RF field oscillations between the antenna of the heating unit and the antenna of the capsule assembly (182). The RFID reader may also transmit, and may be configured to establish two-way communication with the RFID chip of the cartridge.

FIG. 21 is a schematic or block circuit diagram of an RFID controlled heating unit and coupled cartridge with RFID chip assembly (210), where the RFID chip and any associated sensors are contained in the cartridge, cartridge body, or attached thereto. In operation, the induction heating unit operates from AC power, converting that to DC via a rectifier bridge circuit (218), which feeds an AC invertor (217) that powers the primary induction coil (213). Provision is also made for DC power for the digital supporting circuitry including microcontroller 215. Microcontroller 215 receives information from the RFID reader 214 and user interface 216 and is programmed to control the AC inverter output accordingly. Provision is made for ROM and RAM capacity, data and address buses, and so forth as is known in the art. The user interface may include display functions, including temperature display and system alerts, and controls for adjusting the temperature and setting a timer, for example. The functionality of the heating unit may be complex, and optionally includes pot detection and thermal overload protection.

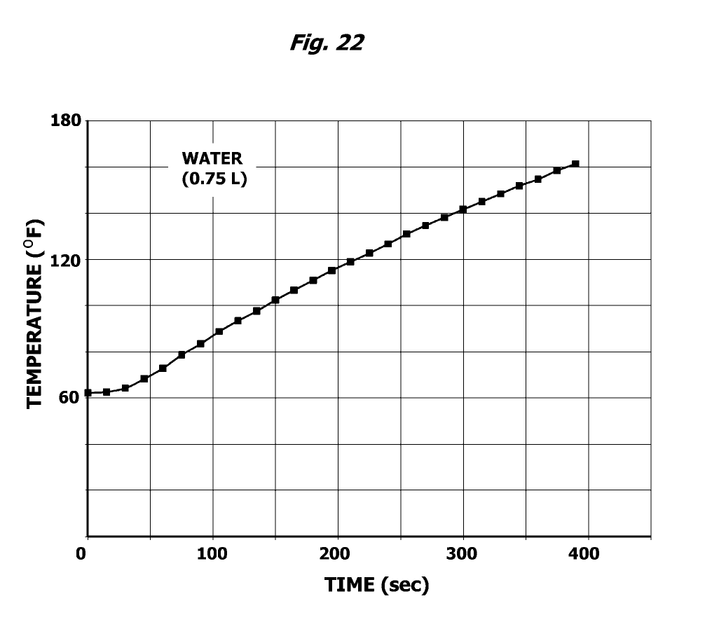

The RFID tag in the cartridge is generally powered passively by capturing RF energy from the primary or secondary coils. Optionally the RFID control circuit can include a “handshake” read-write functionality and other “watchdog” circuitry for ensuring that the cartridge and heating unit will work properly together (component ID verification). The RFID tag in the cartridge need not be a simple transponder, and may contain sensor functions for monitoring temperature in the food or beverage, and includes an A/D converter for conveying sensor information. A “dry pot” algorithm can be programmed to guard against the situation when the cartridge is heated with no liquid in the vessel by determining the rate at which the temperature reading on the RFID capsule rises once the unit is powered on. Since the capsule is thermally insulated from the heatable disk body of the cartridge, the temperature variation would be minimal. Thus, if the temperature increase is below a certain limit, say less 3° F. over 20 seconds taking into account heating initiation lag (see FIG. 22), the unit will turn off Alternatively, a second temperature sensor can read the temperature on the cartridge body and can be used to flag early signs of thermal overload. Load coupling can also be monitored by sensing power dissipation in the inverter LC tank circuit or by monitoring harmonics of the driving frequency as is known in the art.

To establish a handshake, the inductive heating unit or system will read the RFID tag signal coming from the cartridge and compare it with a value in memory to identify the cartridge ID and operating parameters. Power settings may be adjusted based on the ID of the cartridge. Different cartridges may have different codes depending on their intended use. Settings preferred by the user, for example, settings for tea versus coffee, can be stored on board the heating unit. Conversely, as an added safety measure requiring two-way communication between the cartridge and the heating unit, the cartridge can receive a code and compare it with its own database to determine compatibility, sending a flag to the microcontroller if a match is not found.

There are multiple ways the RFID communication between the cartridge and the induction heating unit can be devised. In circuit specific for this application, for example, a chip such as the Maxim MAX6576 (MAXIM, Phoenix Ariz.), if pulse modulation is desired, can drive the load transistor in parallel with the coffee cup's RFID coil. The serial data of the temperature sensor will modulate the load of the coil, which can then be detected in the baseplate RFID sender/sense coil as voltage envelope changes. For this method a transmit oscillator is not required. It can send both serial number and temperature data.

Another RFID solution which is a preferred embodiment in this application is to have a standard RFID tag/reader configuration. A single semiconductor chip like Gentag GT301 (Gentag, Washington D.C.) can perform both identification and temperature readings. It normally only operates up to 60° C., but can be operated up to 100° C. with reduced accuracy. A second generation of the chip should easily work to 100° C. with a +/−0.5° C. accuracy. The RFID tag can communicate with a standard RFID reader.

Cartridges having an embedded RFID tag may be provided with a mating cup or vessel, the cup or vessel being composed substantially of a dielectric material and having walls, lip and a base, wherein the cup or vessel is configured for removably receiving the insertable heating cartridge.

Formerly, vessels made of dielectric materials like ceramic, glass, plastic or paper could not be used for conventional cooktop cooking. The present invention enables the use of this class of cookware with conventional induction cooking systems for the kitchen and desktop systems for the office or home. An inventive departure from the prior art is as follows. Conventional induction systems use pot detection subcircuits to power down in the absence of a pot, a safety feature that prevents heating of small metallic objects. This feature is incorporated in the electronics of the unit. The circuits are designed to detect a ferromagnetic pot of certain size before activation. Thus a combination of a ceramic or glass vessel and an insertable induction heating cartridge on a heating system of the prior art is limited to vessels permitting close proximity of the cartridge to the primary coil. For vessels with a raised bottom surface, the coupling between the induction coil and the inductive cartridge may be insufficient and result in power down. As my experience has shown, even though the magnetic field would be strong enough to heat the cartridge inside the vessel, the system would not work. For new induction heating units with RF capabilities, a RFID tag in communication with the heating unit will by-pass the pot detector and permit heating. This way, even a single cup of water, which otherwise would be a load too small, can be heated and brought to a boil right on the range top by inserting a small cartridge with RFID into a dielectric cup or vessel, thereby eliminating the need for old-fashioned and inefficient electric kettles, ranges, and warmers and expanding the range of inductive cooking to more generally available kitchenware, even china.

Embodiments of the inventive cartridge may also include configurations having one or more safety features. These include, encapsulated in the cartridge body or affixed thereto, i) an RFID tag and antenna configured to respond to a communication protocol for verifying compatibility of said cartridge and an inductive heating unit; ii) encapsulated in said cartridge body, an RFID tag chip and antenna, said cartridge body further comprising a temperature sensor circuit in communication with said RFID tag chip for transmitting a temperature datum to a microcontroller of an inductive heating unit; iii) one or more buoyant cavities, wherein the buoyant cavity is configured for buoying said cartridge in a liquid when said cartridge is not latchedly secured in the cavity of said cup or vessel; or, iv) a layer of inductively heatable material having a Curie temperature less than 600° F., more preferably less than 500° F., and most preferredly about 300° F., where the material is used to form the inductively heatable material, thus reducing the possibility of overheating.

In another embodiment the invention is a cartridge configured to heat a food or beverage in a non-conductive vessel in spite of the limitations imposed by pot detection circuits of modern induction heating units. While pot detection circuits are a safety feature for ensuring that objects such as spoons, lids, and wristwatches, for example are not heated, and for ensuring that a pot is always on the hob when the unit is active, the cartridges of the present invention more efficiently generate heat by being placed inside the vessel. Thus it may be appropriate to defeat the pot detection safety circuit on many induction heating units. As is shown below, surprisingly this can be done while increasing heating efficiency using cartridges of the present invention where the cartridge body comprises a perforated plate.

All the above embodiments the invention are also a method for promoting the use of induction heating appliances with vessels not conventionally used with induction heating appliances, such as those made of china, glass or plastic. The method includes the steps of supplying an inductive heating cartridge of the present invention to a consumer, and supplying instructions the consumer to insert it into a suitable vessel chosen by the consumer and use the combination with an inductive heating appliance.

### EXAMPLES

### Example 1

To form an insertable heating cartridge of the invention, a puck-shaped piece of stainless steel (T304) was cut from stock as supplied by the manufacturer. The stainless steel was 0.03 inches thick and perforated in a regular array with 0.095 inch diameter holes at 0.16 inch intervals, and had a surface area of about 36 square inches. Other cartridges having other material properties, thicknesses, and volume distributions were prepared in a similar way.

### Example 2

FIG. 22 is a plot of temperature versus time for the heating of 0.75 L of water with an inductive immersible cartridge of the invention. A non-ferrous pot was filled with water and a cartridge of the invention was inserted into the inside cavity of the vessel, which was then placed on the hob surface of an induction heating unit (Sunpentown Model SR-1881 Induction Cooktop, City of Industry CA). For the test, the cartridge was immersed inside the vessel in close apposition or proximity to the inside bottom surface of the vessel. The induction heating unit was then activated. The graph of temperature versus time shows a brief lag followed by relatively linear heating kinetics at medium power.

### Example 3

The Sunpentown Model SR-1881 Induction Cooker, which is representative of commercially available induction heating units, is equipped with pot detection circuitry designed to automatically “power down” if no pot is placed on the surface of the heating unit or the pot is removed during heating. For the unit to work, the pot must be ferromagnetic and must have a minimum size.

It was found by trial and error that raising or lowering a metal surface near the surface of the cooktop serves as an index of the success of magnetic coupling required to engage power on the unit. This index is herein termed the “coupling height index”. Regular steel flat cartridges result in heating if placed in close proximity to the surface but not when raised higher. When a sheet of 1018 carbon steel 5×5 inches in diameter and having a thickness of 1 mm was placed on the cooktop in a vessel, the maximal height achieved before automatic power down is 4.4 mm, a less than fully satisfactory result based on the needs of the market. The base of the inside cavity of many ceramic, plastic, or glass vessels is 8 mm or higher relative to the level of the cook top surface. Sheets of wire gauze were also unsatisfactory, resulting in no heating at any height. As a benchmark, the coupling height index of 4.4 mm achieved with a flat sheet of 1018 steel 1 mm thick was taken as a baseline for further experiments.

Various materials and thicknesses were then tested. Unexpectedly, a sheet of T304 martensitic stainless steel, 0.5 mm thick, having a regular array or pattern of perforations 0.095 inches in diameter and spaced 0.16 inches was found to permit heating at a higher elevation from the cooktop, achieving coupling at up to 8.0 mm from the surface—as would be more fully satisfactory for commercial applications. This is a better than expected result with almost double the coupling height index gain.

The perforation patterns that showed the best results to date were an array of 0.095 inch diameter holes at 0.16 inch intervals, which resulted in a coupling height index of 8.0 mm. Based on multiple experiments with various materials and configurations, the increase in coupling height index due to material selection and the increase due to the array of perforations were separated out. It was estimated that the increase in coupling height index due to the array of perforations is about 1.5 mm. The increase in coupling height index due to the material selection, dimensions and the plate thickness is about 2.1 mm. This shows that 40% of the increase in functional elevation was achieved due to the use of a sheet with an array of perforations. An array of dimples may also be used.

Since the magnetic field decreases exponentially with the distance, the increase above baseline becomes very significant. Due to a weakening intensity of the magnetic field as the distance from the surface of the cooktop increases, the size of the inductive load perceived by the cooktop circuitry is expected to be reduced. Surprisingly, the magnetic load of a perforated plate was found to be perceived by the cooktop as greater than a solid plate. It has been found that given a choice of material, thickness, and, more surprisingly, a spaced perforation array will significantly increase the inductive signature of the induction cartridge so that the pot detection circuitry reads a normal load and powers up even though the cartridge is placed at a higher elevation.

Cartridges cut from other sheet stock, wire mesh, and non-perforated sheet stock were not successful in coupling with the heating unit, the perforated sheet material was successfully coupled to the output of the primary coil and heating resulted. The pot detection circuit was compatible for heating a perforated stainless steel sheet immersed in a dielectric vessel, but was not compatible with a solid isotropic stainless steel sheet of similar thickness, and was not compatible with very thin foils or wire gauze.

After many experiments, cartridges formed from perforated stainless steel sheet were found to be more compatible with a conventional induction heating unit than cartridges formed from very thin or solid sheet.

### INDUSTRIAL APPLICABILITY

The invention lends itself to commercial application through the provision and sale of the inventive cartridges for insertion into cups or vessel, where the vessel is provided by the consumer, so that a food or liquid may be heated with a compatible induction heating system without need for a special vessel. The cartridges are immersible and may be removed for washing; such cartridges may be moved from vessel to vessel at will, or may be adapted with attaching functionality so that they may be affixed in a particular vessel. The inventive cartridges may also be sold as a combination with a cup or vessel adapted for their use as a combination, or may be sold as a part of an induction heating system having hob, coil, and compatible electronics, and so forth, while not limited thereto. Although the foregoing invention has been described in some detail by way of illustration and example for purposes of clarity of understanding, it will be clear to one skilled in the art that changes, substitutions, combinations and modifications may be practiced within the scope of the appended claims. Therefore, the scope of the present invention shall be determined not with reference to the above description but shall, instead, be determined by the construction of the appended claims, along with their full scope of equivalents. In general, in the following claims, the terms used should not be construed to limit the claims to one or more specific embodiments disclosed in the specification and the claims, but should be construed to include all possible embodiments along with the full scope of equivalents to which such claims are entitled. Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment.

The appended claims are not to be interpreted as including means-plus-function limitations per 35 USC 112 paragraph 6, unless such a limitation is explicitly recited in a given claim by using the phrase “means for.” And unless the context requires otherwise, throughout the specification and claims which follow, the word “comprise” and variations thereof, such as, “comprises” and “comprising” are to be construed in an open, inclusive sense, that is, as “including, but not limited to”.

All of the U.S. patents, U.S. patent application publications, U.S. patent applications, foreign patents, foreign patent applications and non-patent publications referred to in this specification and/or listed in an Information Data Sheet, are incorporated herein by reference in their entirety.

I claim:

1. A reusably insertable heating cartridge for inductively heating a food or a liquid in an inside cavity of a cup or vessel, said cup or vessel having a base and walls, said base composed substantially of a dielectric material, which comprises:
a) a cartridge body for insertion into said inside cavity of said cup or vessel, said cartridge body having upper face, peripheral edge and undersurface, and further comprising a sheet or layer of an inductively heatable material, said sheet or layer having dimensions, volume distribution, and material properties configured to dissipate power as heat when operatively coupled to an external oscillating magnetic field penetrating said base or walls and contacting said cartridge body;
b) further comprising a latching functionality for securing said cartridge body within said cavity of said cup or vessel, wherein said latching functionality is disengageable by the user for transferring said cartridge from cup to cup or vessel to vessel; and
c) wherein optionally said cartridge body comprises an exterior sanitary coating of a food- or liquid-compatible material.

2. The insertable heating cartridge of claim 1, wherein said latching functionality is a mechanical latch configured to secure said cartridge within said inside cavity of said cup or vessel.

3. The insertable heating cartridge of claim 2, wherein said mechanical latch comprises at least one elastic projection from said peripheral edge of said cartridge body, wherein said elastic projection is configured for grippingly securing said cartridge body between opposing walls of said cup or vessel.

4. The insertable heating cartridge of claim 2, wherein said mechanical latch comprises a clippable appendage projecting from said peripheral edge of said cartridge body, wherein said clippable appendage is configured for grippingly securing said cartridge to a lip of said walls of said cup or vessel.

5. The insertable heating cartridge of claim 2, wherein said mechanical latch comprises a friction collar applied to a centrally disposed hole in said cartridge body and adapted for securing said cartridge to a post projecting centrally from said base of said cup or vessel, or a friction collar applied to said peripheral edge of said cartridge body and adapted for securing said cartridge peripherally to said walls of said cup or vessel.

6. The insertable heating cartridge of claim 2, wherein said mechanical latch comprises latching arms attached to a bezel around a centrally disposed hole in said cartridge body, said latching arms having barbs for mating with a barb-receiving post projecting centrally from said base of said cup or vessel, or latching arms attached to said peripheral edge of said cartridge body for mating with barb receiving receptacles in said walls of said cup or vessel.

7. The insertable heating cartridge of claim 2, wherein said mechanical latch comprises at least two contralaterally placed pins or slots on said peripheral edge of said cartridge body, wherein said pins or slots are configured for engaging mating threadable channels or bosses in said vessel.

8. The insertable heating cartridge of claim 1, wherein said latching functionality is a magnetic latch, said magnetic latch comprising a combination of a magnet applied externally on the base or walls of said cup or vessel or encapsulated within said base or walls and a magnetically responsive element in said cartridge body, said magnet for magnetically attracting said magnetically responsive element and thereby magnetically secured said cartridge body within said inside cavity of said cup or vessel.

9. The insertable heating cartridge of claim 1, wherein said sheet or layer of inductively heatable material is composed of iron, cast iron, steel, carbon steel, stainless steel, martensitic stainless steel, cobalt steel, chrome steel, nickel steel, silicon steel, magnetic stainless steel, spring steel, mu-metal, aluminum, copper or an alloy or a combination thereof.

10. The insertable heating cartridge of claim 1, wherein said cartridge body further embodies a safety feature selected from the group consisting of:
a) encapsulated in said cartridge body, an RFID tag and antenna configured to respond to a communication protocol for verifying compatibility of said cartridge and an inductive heating unit;
b) encapsulated in said cartridge body, an RFID tag and antenna, said cartridge body further comprising a temperature sensor circuit in communication with said RFID tag for transmitting a temperature datum to a microcontroller of an inductive heating unit;
c) within said cartridge body, a buoyant cavity, wherein said buoyant cavity is configured for buoying said cartridge in a liquid when said cartridge is not latchedly secured in said cavity of said cup or vessel; and
d) for forming said sheet or layer of an inductively heatable material, a inductively heatable material selected for a Curie temperature of less than 600° F., more preferably less than 500° F., and most preferredly about 300° F.

11. A combination for inductively heating a food or a liquid, which comprises
a) an insertable heating cartridge of claim 1;
b) a cup or vessel of said combination, said cup or vessel having walls, lip and a base, wherein said cup or vessel is configured for receiving and reversibly securing said insertable heating cartridge within said inside cavity by a mechanical latching functionality or a magnetic latching functionality, and wherein said latching functionality is disengageable by the user for transferring said insertable heating cartridge from cup to cup or vessel to vessel.

12. An inductive heating unit, wherein said inductive heating unit is configured to operate with said heating cartridge of claim 1.

13. A reusably insertable heating cartridge for inductively heating a food or a liquid in an inside cavity of a cup or vessel, said cup or vessel having a base and walls, said base composed substantially of a dielectric material, which comprises:
a) a cartridge body for insertion into said inside cavity of said cup or vessel, said cartridge body having upper face, peripheral edge, and undersurface, and further comprising a sheet or layer of an inductively heatable material, said sheet or layer having dimensions, volume distribution, and material properties configured to dissipate power as heat when operatively coupled to an external oscillating magnetic field penetrating said base or walls and contacting said cartridge body; and
b) encapsulated in said cartridge body,
i) an RFID chip and antenna;
ii) optionally a temperature sensor in electronic communication with said RFID tag and antenna; and
c) optionally wherein said cartridge body comprises an exterior sanitary coating of a food- or liquid-compatible material.

14. The insertable heating cartridge of claim 13, wherein said sheet or layer of inductively heatable material is composed of iron, cast iron, steel, carbon steel, stainless steel, martensitic stainless steel, cobalt steel, chrome steel, nickel steel, silicon steel, magnetic stainless steel, spring steel, mu-metal, aluminum, copper or an alloy or a combination thereof.

15. A combination for inductively heating a food or a liquid, which comprises
a) an insertable heating cartridge of claim 13;
b) a cup or vessel of said combination, wherein said cup or vessel is configured for removably receiving said insertable heating cartridge.

16. An inductive heating unit, wherein said inductive heating unit is configured to operate with said insertable heating cartridge of claim 13.

17. A reusably insertable heating cartridge for inductively heating a food or a liquid in an inside cavity of a cup or vessel, said cup or vessel having a base and walls, said base composed substantially of a dielectric material, which comprises:
a) a cartridge body for insertion into said inside cavity of said cup or vessel, said cartridge body having upper face, peripheral edge and undersurface,
b) wherein said cartridge body comprises a sheet of an inductively heatable material; and
wherein said sheet is further characterized as having an array of perforations or dimples configured to increase apparent inductive load resistance of said heating cartridge due to eddy current losses when operatively coupled to an external oscillating magnetic field penetrating said base or walls and contacting said cartridge body.

18. The insertable heating cartridge of claim 17, wherein said sheet of inductively heatable material is composed of iron, cast iron, steel, carbon steel, stainless steel, martensitic stainless steel, cobalt steel, chrome steel, nickel steel, silicon steel, magnetic stainless steel, spring steel, mu-metal, aluminum, copper, an inductively heatable material selected for a Curie temperature of less than 600° F., or an alloy or a combination thereof.

19. A combination for inductively heating a food or a liquid, which comprises
a) an insertable heating cartridge of claim 17;
b) a cup or vessel of said combination, wherein said cup or vessel is configured for removably receiving said insertable heating cartridge.

20. An inductive heating unit, wherein said inductive heating unit is configured to operate with said insertable heating cartridge of claim 17.
